(19) United States
(12) Patent Application Publication
(10) Pub. No.: US 2022/0044172 A1
(43) Pub. Date: Feb. 10, 2022

(54) METHOD, SYSTEM AND TERMINAL DEVICE FOR OPERATION MANAGEMENT OF AIRCREW

(71) Applicant: Hangzhou Pi-solution Information Technology Co.,Ltd, Hangzhou (CN)

(72) Inventors: Qiang GONG, Hangzhou (CN); Zheming ZHANG, Hangzhou (CN); Zhiyong RUAN, Hangzhou (CN); Chunping LIU, Hangzhou (CN); Dubing XIANG, Hangzhou (CN); Ziheng XU, Hangzhou (CN)

(73) Assignee: Hangzhou Pi-solution Information Technology Co.,Ltd, Hangzhou (CN)

(21) Appl. No.: 17/204,821

(22) Filed: Mar. 17, 2021

(30) Foreign Application Priority Data
Aug. 6, 2020 (CN) 202010781770.X

(51) Int. Cl. G06Q 10/06; G06F 17/11

(52) U.S. Cl. CPC G06Q 10/06312; G06F 17/11; G06Q 10/06314; G06Q 10/063118

(57) ABSTRACT

A method for operation management of aircrew includes: determining multiple initial duties composed of a number of flights according to an obtained flight schedule, determining multiple initial pairings each including a start half pairing and an end half pairing according to the initial duties, selecting multiple candidate pairings from the multiple initial pairings with the objective of minimum total flight operating cost, and determining a roster schedule of the aircrew with a series of pairings according to the candidate pairings and obtained information of the aircrew. A process of generating the pairings includes: first, building two half pairings, namely a start half pairing and an end half pairing, and then combining the half pairings with tasks of an other base to flexibly connect the pairings of the other base through half pairing bridging.

### CROSS REFERENCE TO THE RELATED APPLICATIONS

This application is based upon and claims priority to Chinese Patent Application No. 202010781770.X, filed on Aug. 6, 2020, the entire contents of which are incorporated herein by reference.

### TECHNICAL FIELD

The present invention relates to the field of computers, and in particular to a method, system and terminal device for operation management of aircrew.

### BACKGROUND

An airline with multiple (≥2) bases generally has a mismatch between the aircrew resources of the bases and the number of flights due to differences in the aviation market and distributions of flight resources. A base with relatively scarce aircrew resources cannot satisfy the demands for aircrew resources with regard to the flights for which it is responsible. If it does not receive support from other bases, the ill-equipped base has to cancel its flights. This results in a substantial loss of the airline's overall revenue. On the other hand, a base with relatively sufficient aircrew resources faces the problem of “unsatisfactory flying hours”, that is, the monthly flying hours of aircrews are lower than the legal monthly flying hours, which affects the income and satisfaction of the aircrew and consequently causes a certain negative impact on flight safety.

A flight schedule includes a flight number, a flight departure airport, a flight arrival airport, a flight departure time, a flight arrival time, the number of crews, and other logistical information. The formulation of the flight schedule mainly includes: based on the transportation demand forecast, determining a reasonable flight frequency, flight time, and the like according to the distribution of demands on the airline's various route markets over a period of time, airport slots resources and fleet resources, in order to maximize the airline's share in the transportation market to increase revenue. However, the number of aircrew resources of the base is not significantly related to the flight planning, and in the process of flight planning does not fully consider the aircrew resources of each base. In this case, it is difficult to coordinate the arrangements for the flights and aircrew resources, resulting in a less than ideal correspondence between the number of aircrew resources and the number of flights.

At present, aircrew scheduling for airlines is mostly by manual, and thus the quality of schedule depends on artificial experience. Some large and medium-sized airlines utilize optimization techniques to arrange aircrews, which mainly include: step 1, formulating flight schedule for a period, considering regulations of the Civil Aviation Administration and certain rules of the airline, and generating multiple pairings containing multiple flights from base departure to the end; and step 2, based on the multiple pairings obtained above, considering aircrew information (such as qualifications and working status) and safety regulations, and allocating all pairings to the legal aircrews.

However, due to the uneven distribution of bases to which the aircrews belong, a large number of aircrews are required to be dispatched across these bases. The reason for this is that aircrew scheduling is also limited by the algorithm model in addition to the business factors described above. The key to the inability of the existing model to solve the problem of uneven distribution of the bases to which the aircrews belong is that the flight matching (pairing optimization) module and the aircrew assignment (rostering optimization) module are not connected. They are independent from each other.

The departure station and the arrival station of the generated pairing must be the same base, and the base must be the base of the aircrew performing the pairing. This means that aircrews can only depart from their base and eventually return to the base. This method has the disadvantages of inflexible utilization of aircrews and the inability to comprehensively coordinate and arrange the aircrew resources of each base, and therefore, cannot provide effective support for other bases.

In the stage of assigning the pairings to the aircrews, existing optimization algorithms only consider the time continuity of the pairings, but fail to consider the spatial connection relationship of the pairings. This causes the following problems: firstly, it is not likely that pairings between different bases are properly assigned; secondly, special preassigned activities that need to be integrated and performed on other stations are not concurrently and automatically implemented, such as regular retraining.

The pairing assignment of the aircrew needs to follow strict safety regulations. As an independent functional module, the regulation engine is closely integrated with optimization algorithms. Once the mode of the pairings changes, it will inevitably cause a consequential change in the regulation engine, thereby increasing the difficulty and cost of airline management.

### SUMMARY

The embodiments of the present invention provide a method, system and terminal device for operation management of aircrew to solve the problem that the prior art is difficult to coordinate the arrangements for flights and aircrew resources, resulting in an increased difficulty and high cost of airline management.

In order to solve the above-mentioned technical problems, the present invention is implemented by the following technical solutions.

The first aspect provides a method for operation management of aircrew, including:

determining multiple initial duties composed of a number of flights according to an obtained flight schedule, wherein the flight schedule includes properties, such as the flight number, the flight departure airport, the flight arrival airport, the flight departure time, and the flight end time;

determining multiple initial pairings according to the multiple initial duties, wherein each of the initial pairings includes a start half pairing and an end half pairing; the start half pairing and the end half pairing are duties with different departure base and arrival bases; the departure base of the start half pairing is the same as the end base of the end half pairing, and the departure base of the start half pairing is a base to which the aircrews belong;

determining multiple candidate pairings from the multiple initial pairings by taking a minimum total flight operating cost as an objective function;

determining a schedule of the aircrews in the multiple candidate pairings according to the candidate pairings and obtained information of the aircrews.

The second aspect provides a system for operation management of aircrew, including:

a first determination module, configured to determine multiple initial duties composed of a number of flights according to an obtained flight schedule, wherein the flight schedule includes properties, such as the flight number, the flight departure airport, the flight arrival airport, the flight departure time, and the flight end time;

a second determination module, configured to determine multiple initial pairings according to the multiple initial duties, wherein each of the initial pairings includes a start half pairing and an end half pairing; the start half pairing and the end half pairing are duties with different departure airports and arrival airports; the departure base of the start half pairing is the same as the end base of the end half pairing, and the departure base of the start half pairing is a base to which the aircrews belong;

a pairing determination module, configured to determine multiple candidate pairings from the multiple initial pairings by taking a minimum total flight operating cost as an objective function;

an aircrew determination module, configured to determine a schedule of the aircrew in the multiple candidate pairings according to the candidate pairings and obtained information of the aircrews.

The third aspect provides a terminal device, including: a memory, a processor, and a computer program stored on the memory and running on the processor, and the computer program is executed by the processor to implement the steps of the method described in the first aspect.

The fourth aspect provides a computer-readable storage medium, a computer program is stored on the computer-readable storage medium, and the computer program is executed by a processor to implement the steps of the method described in the first aspect.

In an embodiment of the present invention, firstly, multiple initial duties composed of a number of flights are determined according to an obtained flight schedule, and then multiple initial pairings each including a start half pairing and an end half pairing are determined according to the initial duties. After that, multiple candidate pairings are determined from the multiple initial pairings by taking a minimum total flight operating cost as an objective function. Finally, a schedule of the aircrew in the multiple candidate pairings is determined according to the determined candidate pairings and obtained information of the aircrews. In the embodiment of the present invention, a process of generating the pairings includes: firstly building two half pairings, namely a start half pairing and an end half pairing, and then combining the half pairings with tasks of an other base to flexibly connect the pairings of the other base through half pairing bridging to maximize the coverage of the tasks, thereby ensuring a balanced and reasonable utilization of aircrew resources and the legitimacy of aircrew arrangements, while minimizing the aircrew costs.

### BRIEF DESCRIPTION OF THE DRAWINGS

The drawings described herein are used to provide a further understanding of the present invention and constitute a part of the present invention. The exemplary embodiments of the present invention and their descriptions are used to explain the present invention, and do not constitute an improper limitation to the present invention.

In the figures:

FIG. 1 is a flow chart of a method for operation management of aircrew according to an embodiment of the present invention;

FIG. 2 is a schematic diagram of a system for operation management of aircrew according to an embodiment of the present invention;

FIG. 3 is a structural schematic diagram of the hardware of a terminal device according to an embodiment of the present invention; and

FIG. 4 is a structural schematic diagram of pairings according to an embodiment of the present invention.

### DETAILED DESCRIPTION OF THE EMBODIMENTS

The technical solutions in the embodiments of the present invention will be clearly and completely described below with reference to the drawings in the embodiments of the present invention. Obviously, the described embodiments are part of the embodiments of the present invention, rather than all the embodiments. Based on the embodiments of the present invention, all other embodiments obtained by those of ordinary skill in the art without creative efforts shall fall within the scope of protection of the present invention.

The embodiments of the present invention provide a method, system and terminal device for operation management of aircrew. According to the method for operation management of aircrew, firstly, two half pairings, namely a start half pairing and an end half pairing are built, and then an optimization is applied to combine the half pairings with pairings of an other base to improve utilization; and candidate pairings of the aircrew and a schedule of the aircrews in each flight segment and each flight of the pairings are determined through a preset pairing scheduling algorithm to reasonably arrange the aircrews in the generated candidate pairings and flexibly connect the pairings of the other base to maximize the coverage of multiple tasks, such as flight pairings, standby tasks and other special tasks, so as to ensure a balanced and reasonable utilization of aircrew resources, reflect the fairness of aircrew scheduling, and ensure the legality of aircrew work arrangements, while minimizing aircrew costs.

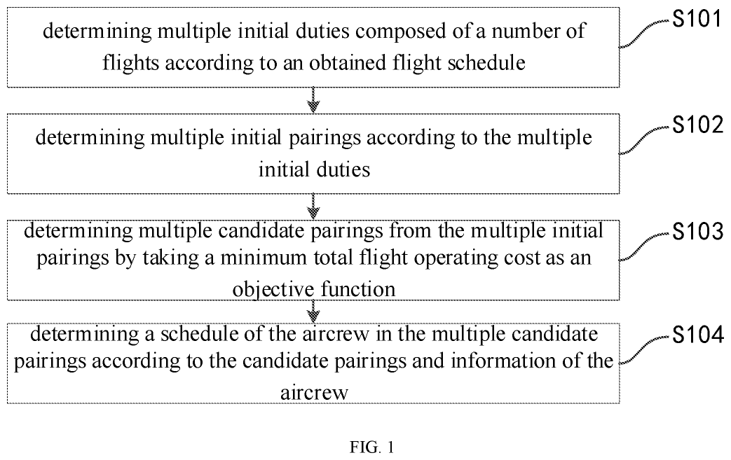

Referring to FIG. 1, a flow chart of a method for operation management of aircrew according to an embodiment of the present invention is shown. The method for operation management of aircrew includes: step S101 to step S104.

Step S101, according to an obtained flight schedule, multiple initial duties composed of a number of flights are determined.

The flight schedule includes properties, such as the flight number, the flight departure airport, the flight arrival airport, the flight departure time, the flight end time and so on.

Data used in the embodiments of the present invention include: flight plan data, information of the aircrews, and flight regulation parameters.

Specifically, the flight plan data include a flight schedule, that is, the flight number, the flight departure airport, the flight arrival airport, the flight departure time, the flight arrival time, the number of aircrews required, and so on. The number of flights can also be obtained according to the flight schedule.

The information of the aircrews includes crew qualifications, aircrew levels, aircrew historical flight data, and so on. The number of aircrew resources, bases, and training arrangements can also be obtained based on the information of the aircrew.

The flight regulation parameters include the safety regulations of the Civil Aviation Administration and airline-specific regulations, such as the minimum flight connection time, the maximum duty time, and the maximum length of the pairings of the base.

Step S102, multiple initial pairings are determined according to the multiple initial duties.

Each of the initial pairings includes a start half pairing and an end half pairing. The start half pairing and the end half pairing are duties with different departure airports and arrival airports. The departure base of the start half pairing is the same as the end base of the end half pairing, and the departure base of the start half pairing is a base to which the aircrews belong.

A candidate pairing is composed of multiple flight segments. The candidate pairing includes a start half pairing, multiple intermediate duties and an end half pairing.

Specifically, the intermediate duties connect the start half pairing and the end half pairing to form a complete pairing, and the intermediate duties are several initial duties including non-departure bases.

For example, the start half pairing is location A-location B, the end half pairing is location B-location A, the intermediate duties can be location B-location C-location D-location B, location B-location E-location B, that is, the final pairing is: location A-location B, location B-location C-location D-location B, location B-location E-location B, location B-location A.

Alternatively, the start half pairing is location A-location B, the end half pairing is location C-location A, the intermediate duties can be location B-location C-location D-location B, location B-location C, that is, the final pairing is: location A-location B, location B-location C-location D-location B, location B-location C, location C-location A.

In other words, in the embodiments of the present invention, the departure base of the start half pairing is the same as the end base of the end half pairing, while the end base of the start half pairing and the departure base of the end half pairing can be the same or different, that is, the intermediate duties may contain a half pairing.

In step S103, with the minimum total flight operating cost as the objective function, the selected pairings are determined from the initial pairings.

Specifically, taking the minimum total flight operating cost as the objective function and the initial pairings above as input pairings, then pairings according to the objective function are determined as the candidate pairings to minimize the aircrew costs.

In step S104, according to the candidate pairings and information of the aircrew, a schedule of the aircrew based on the candidate pairings is determined.

In the embodiment of the present invention, multiple initial duties composed of a number of flights are determined according to the obtained flight schedule, and then the initial pairings with each including a start half pairing and an end half pairing are determined according to the initial duties. After that, candidate pairings are determined from the initial pairings by taking the minimum total flight operating cost as the objective function. Finally, a schedule of the aircrews in the multiple candidate pairings is determined according to the determined candidate pairings and information of the aircrew. In the embodiments of the present invention, the process of generating pairings includes: firstly building two half pairings, namely a start half pairing and an end half pairing, and then combining the half pairings with the tasks of the other base to flexibly connect the pairings of the other bases. Through half pairing bridging, it's possible to maximize the coverage of the tasks, ensuring a balanced and reasonable utilization of aircrew resources and the legitimacy of aircrew arrangements, as well as minimizing the aircrew costs.

In a possible implementation of the present invention, the step of determining initial pairings according to the initial duties includes the following steps:

multiple pairs of initial duties are selected from the initial duties, wherein the departure base of the first initial duty is the same as the end base of the second initial duty in each pair;

any pair of initial duties are used as a start half pairing and an end half pairing of one initial pairing; and

a pairing including the start half pairing and the end half pairing is used as an initial pairing, wherein the initial pairing includes the start half pairing, multiple intermediate duties, and the end half pairing, and the intermediate duties are initial duties including non-departure bases.

In the embodiment of the present invention, firstly, two half pairings, namely the two half pairings in which the departure base of the first initial duty is the same as the end base of the second initial duty, are determined from the initial duties as the start half pairing and the end half pairing of the initial pairing. Then pairings of an other base are built between the start half pairing and the end half pairing to obtain various combinations. Since the start half pairing and the end half pairing are determined first, the initial pairings obtained are closer to the final candidate pairings to reduce the amount of calculation in the middle, so the pairings of the other base are flexibly connected in the middle.

In a possible implementation of the present invention, the step of determining candidate pairings from initial pairings by taking the minimum total flight operating cost as the objective function specifically includes the following steps:

the initial pairings are calculated by taking the minimum total flight operating cost as the objective function; and

candidate pairings are calculated by minimum satisfying the objective function.

In the embodiment of the present invention, the initial pairings determined above are screened by the flight operating cost to obtain the final candidate pairings to solve a multi-objective optimization problem of pairing scheduling, and the determined candidate pairings can reduce the total cost to obtain an optimal plan by minimizing the objective function.

In a possible implementation of the present invention, the objective function is expressed as follows:

$$P = min {\sum }_{i ∈ F} {\sum }_{j ∈ G} {B}_{ij} {x}_{ij} ;$$

wherein, P represents the total flight operating cost; F represents the total number of flights; G represents a set of pairings; βᵢⱼ represents an operating cost of a flight allocated to a pairing; xᵢⱼ indicates whether a flight i is allocated to a pairing j, when the flight i is allocated to the pairing j, xᵢⱼ is 1, and when the flight i is not allocated to the pairing j, xᵢⱼ is 0.

It should be noted that if a flight is allocated to a pairing, a certain cost will be incurred. Bᵢⱼ represents the operating cost of a flight allocated to a pairing and includes multiple dimensions, such as salary expenses, overnight costs, and flight uncovered (that is, unfinished) costs.

The preset constraints include: a flight allocation constraint, an overlapping flights constraint, an aircraft type matching constraint, a base resource limit constraint, and a limit constraint of the number of deadheads.

Specifically, a flight can only be allocated to one pairing at most, that is, the above model needs to satisfy the flight allocation constraint:

$${\sum }_{j ∈ G} {x}_{ij} + {y}_{i} = 1 , ∀ i ∈ F ;$$

two flights that overlap in time cannot be allocated to the same pairing, that is, the above model also needs to satisfy the overlapping flights constraint: xᵢⱼ+xₘⱼ≤1,∀(i,m)∈S_{TOL},∀j∈G;

aircraft types of all flights in the pairings must be matched, that is, the above model also needs to satisfy the aircraft type matching constraint: xᵢⱼ+xₘⱼ≤1,∀(i,m)∈S_{Fleet},∀j∈G;
the generated pairings must not exceed the base resource limit, that is, the above model also needs to satisfy the base resource limit constraint:

$${\sum }_{j ∈ {B}_{k}} {x}_{ij} \leq {M}_{Limit} , ∀ j ∈ G ;$$

the number of deadheads contained in the generated pairings must not exceed the specified limit, that is, the above model also needs to satisfy the limit constraint of the number of deadheads:

$${\sum }_{j ∈ D} {x}_{ij} \leq {D}_{Limit} , ∀ j ∈ G ;$$

base intraday half pairing number limit constraint:

$${\sum }_{j ∈ {E}_{c}} {x}_{ij} \leq {N}_{Limit} , ∀ j ∈ G ;$$

base intercontinental half pairing number limit constraint:

$${\sum }_{j ∈ p} {x}_{ij} \leq {P}_{Limit} , ∀ j ∈ G ;$$

the limit constraint of the number of deadheads contained in the half pairing:

$${\sum }_{j ∈ D} {x}_{ij} \leq {D}_{Limit} , ∀ j ∈ G ;$$

wherein, yᵢ represents a slack variable and equals 1 when flight i is allocated to a pairing, otherwise yᵢ equals 0; xₘⱼ indicates whether the flight m is allocated to the pairing j; S_{TOL} represents a set of pairwise flights overlapping in time; S_{Fleet} represents a set of mismatched flight aircraft types; Bₖ represents a set of all pairings belonging to a base k; M_{Limit} represents a resource limit of the base k; D represents a set of all pairings including deadheads; D_{Limit} represents a limit of the number of deadheads in an optimization period; E_{c} represents a half pairing starting from a base E on the c^{th} day; N_{Limit} represents a resource limit of supporting other bases by the base E on a single day; p represents a set of intercontinental route-containing half pairings starting from base p; P_{Limit} represents the limit of the total number of the intercontinental route-containing half pairings allowed to be generated by the base p in the optimization period.

Due to a large number of legal pairings, for small-scale problems, it is possible to try to generate all legal pairings. In reality, however, almost all airlines face large-scale problems with numerous additional complex constraints, making traditional integer programming difficult to accurately characterize the problem or even unable to solve the model. Therefore, by using the above model, an initial solution can be generated through a heuristic algorithm. The original problem is decomposed into a restrictive main problem containing only some variables and a sub-problem to generate new variables. The advantage of the column generation method is its ability to generate optimal solutions while determining their optimality only through sub-problems without enumerating all variables and examining all solutions, thus the column generation method can effectively control the problem scale.

In a possible implementation of the present invention, the step of determining the pairings satisfying the constraints as the candidate pairings of the aircrew includes: minimizing the total flight operating cost, and determining pairings with flight plan data and flight regulation parameters satisfying the constraints as the candidate pairings of the aircrew.

In other words, among the pairings satisfying the above constraint conditions, pairings with the minimum total flight operating cost are determined as the candidate pairings to minimize the total flight operating cost and maximize revenue while satisfying various requirements.

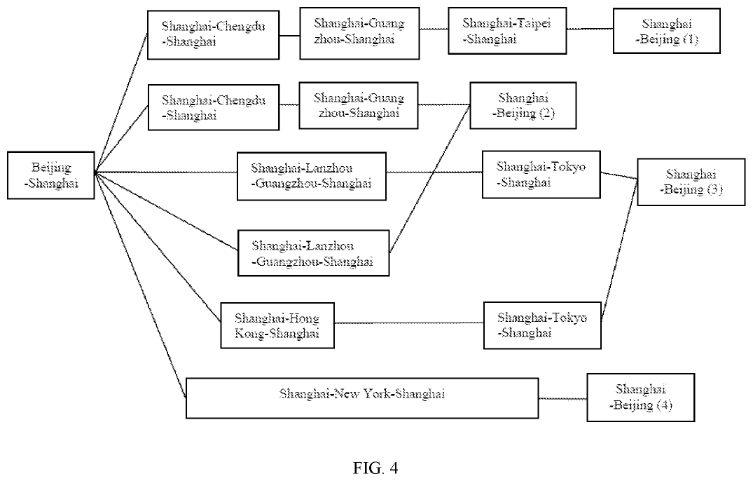

After being generated, the pairings and the half pairings are allocated to the aircrews, that is, enter a half pairing dispatch optimization stage. The pairings all start from the base to which the aircrews belong and eventually return to the same base. In this regard, in the dispatch process, when tasks are allocated to the aircrews, only the time sequence between the pairings needs to be considered, while the spatial sequence between the pairings doesn't. However, both the time sequence and the spatial sequence need to be considered simultaneously when dispatching the half pairings. In a half pairing model, when one task (pairing or half pairing of the other base) is allocated to the aircrews in each step, the corresponding half pairing must be searched to form a complete pairing. As shown in FIG. 4, after the aircrews arrive at an other base through the half pairing, there can be various combinations of connection modes, but in each connection mode, a half pairing must be connected between the beginning and the end.

As shown in FIG. 4, each of the four routes 1-4 form a complete closed pairing, wherein each route includes half pairings, and the closed pairings and the non-closed pairings are combined to solve the problem caused by the uneven distribution of bases to which the aircrews belong, which makes the task allocation more convenient while lowering the total cost.

In a possible implementation of the present invention, the step of determining the schedule of the aircrew in the multiple candidate pairings according to the candidate pairings and information of the aircrew includes the following steps:

according to the candidate pairings and information of the aircrew, the schedule of the aircrew with the minimum flight operating cost is determined;

it is determined whether the schedule of the aircrew obeys the flight regulation parameters; and

when the schedule of the aircrew obeys the flight regulation parameters, the current schedule is determined to be the schedule of the aircrew in multiple flight segments and multiple flights.

In the embodiment of the present invention, when generating the schedule of the aircrew, it is necessary to comprehensively consider aircrew information, historical work records, possessed qualifications, preassigned activities, and vacations of the aircrew. The historical records generally contain data accumulated to date for each of the above attributes, such as the cumulative flying hours of a pilot this year, personnel qualifications such as aircraft types a pilot is eligible for, and eligibility of a pilot for taking off and landing at relevant complex airports. According to the determined candidate pairings and information of the aircrew, a schedule of the aircrew with the minimum cost is firstly determined, and then it is determined that whether the schedule is legal according to the flight regulation parameters. If the schedule is illegal, a part of the aircrews are selected to exchange tasks with each other until the flight regulation parameters are satisfied, that is, the situation described in the following embodiments. The technical solution of the embodiment of the present invention provides reasonable aircrew scheduling while lowering the flight operating cost, thereby improving the total revenue of the flight operation.

In a possible implementation of the present invention, according to the candidate pairings and the information of the aircrew, the step of determining the schedule of the aircrew with the minimum flight operating cost includes the following steps:

according to the information of the aircrew, positions of the aircrew in multiple candidate pairings are determined, including positions in the start half pairing, positions in the intermediate duties or positions in the end half pairing; and

according to the flight operating cost, the schedule of the aircrew with the minimum flight operating cost is determined.

In other words, after the candidate pairings are determined, the aircrews are arranged in each pairing to minimize the flight operating cost.

In a possible implementation of the present invention, the method for operation management of aircrew further includes the following steps:

when the schedule of the aircrew violates the flight regulation parameters, part of the aircrew are selected to exchange schedules until the flight regulation parameters are satisfied; and

the schedule satisfying the flight regulation parameters is used as the schedule of the aircrew in multiple flight segments and multiple flights.

In other words, it is necessary to not only minimize the flight operating cost, but also make the scheduling of the aircrew reasonable and fair.

In a specific embodiment of the present invention, the total flying hours of the entered flight schedule are 6564 (the total flying hours of all flights).

(1) Results of the current method: the number of pairings is 1053, the number of deadheads is 0, the number of overnight stays is 68, the average daily flying hours are 6.23, and the total cost is 127,083.

(2) Results of using the above optimization algorithm under different scenario settings:

Scenario 1: no flight transfer and setting allowed

The number of pairings is 1049, the number of deadheads is 0, the number of overnight stays is 43, the average daily flying hours are 6.23, and the total cost is 125039, which is reduced by 1.61%.

Scenario 2: one pairing is allowed to perform flight transfer once at most, and setting is allowed.

The number of pairings is 996, the number of deadheads is 21, the number of overnight stays is 59, the average daily flight time are 6.58, and the total cost is 122,671, which is reduced by 3.47%.

In other words, the method for operation management of aircrew provided by the present invention can reduce the flight operating cost to increase the revenue.

In a specific embodiment of the present invention, by combining the whole pairings and the half pairings, the aircrew of an airline are specifically arranged as follows.

The airline has 75 aircrafts and mainly operates international routes, of which the number of long-range wide-board passenger aircraft exceeds two-thirds of the fleet size. In addition to its domestic flight attendants, the airline has 5 foreign aircrew bases in three countries, with nearly 700 foreign aircrews. The foreign aircrews need to fly to the airline's main base several times, and after performing several flight tasks, return to the other base where the aircrews are located.

By means of the embodiment of the present invention, 57% of scheduling human resources can be saved. Three shifts are cancelled directly, only one daily day shift is retained for schedulers. Leaping from manual scheduling to automatic scheduling, and evolving the prior manual intensive scheduling to intelligent analysis scheduling. The work of schedulers is no longer the tedious manual scheduling, but focuses on analyzing the monthly schedule and the actual situation of the aircrews, so as to tuning parameters for scenarios of the optimizer. In this way, customized aircrew scheduling is realized with improved fairness.

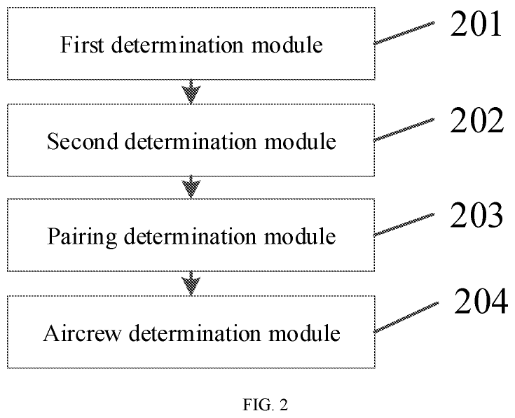

An embodiment of the present invention further provides a system for operation management of aircrew. As shown in FIG. 2, which is a schematic diagram of the system for operation management of aircrew according to the embodiment of the present invention. The system includes: the first determination module 201, the second determination module 202, the pairing determination module 203, and the aircrew determination module 204.

Specifically, the first determination module 201 is configured to determine multiple initial duties composed of a number of flights according to an obtained flight schedule, wherein the flight schedule includes the flight number, the flight departure airport, the flight arrival airport, the flight start time and the flight end time information. The second determination module 202 is configured to determine multiple initial pairings according to the multiple initial duties, wherein each of the initial pairings includes a start half pairing and an end half pairing. The start half pairing and the end half pairing are duties with different departure airports and arrival airports. The departure base of the start half pairing is the same as the arrival base of the end half pairing, and the departure base of the start half pairing is the base to which the aircrew belong. The pairing determination module 203 is configured to select multiple candidate pairings from the multiple initial pairings with the objective of minimum total flight operating cost. The aircrew determination module 204 is configured to determine a roster of the aircrew with a series of candidate pairings based on the pairings information and information of the aircrew.

In the embodiment of the present invention, the first determination module 201 determines multiple initial duties composed of a number of flights according to the obtained flight schedule, and then the second determination module 202 determines multiple initial pairings each including a start half pairing and an end half pairing based on the initial duties. The pairing determination module 203 selects multiple candidate pairings from the multiple initial pairings with the objective of minimum total flight operating cost. Finally, the aircrew determination module 204 determines the roster schedule of the aircrew with a series of candidate pairings according to the determined candidate pairings and the obtained information of the aircrew. In the embodiment of the present invention, the process of generating the pairings includes: firstly building two half pairings, namely a start half pairing and an end half pairing, and then combining the half pairings with tasks of other bases to flexibly connect the pairings of the other base through half pairing bridging, to maximize the coverage of tasks, thereby ensuring a balanced and reasonable utilization of aircrew resources and the legitimacy of aircrew arrangements, while minimizing the aircrew costs.

Further, the second determination module 202 is configured to:

select multiple pairs of initial duties from the multiple initial duties. For each pair of initial duties, the departure base of the first initial duty is the same as the end base of the second initial duty;

use any pair of initial duties as a start half pairing and an end half pairing of an initial pairing; and

use a pairing including the start half pairing and the end half pairing as the initial pairing, wherein the initial pairing includes the start half pairing, multiple intermediate duties, and the end half pairing, and the intermediate duties are initial duties including non-departure bases.

Further, the pairing determination module 203 is configured to:

calculate the multiple initial pairings by taking the minimum total flight operating cost as the objective function; and

calculate the candidate pairings by minimizing the objective function.

The objective function is expressed as the following formula:

$$P = min {\sum }_{i ∈ F} {\sum }_{j ∈ G} {B}_{ij} {x}_{ij} ;$$

the constraint conditions of the objective function include:

$${\sum }_{j ∈ G} {x}_{ij} + {y}_{i} = 1 , ∀ i ∈ F ;$$

$${x}_{ij} + {x}_{m j} \leq 1 , ∀ ( i , m ) ∈ {S}_{T O L} , ∀ j ∈ G ;$$

$${x}_{ij} + {x}_{m j} \leq 1 , ∀ ( i , m ) ∈ {S}_{Fleet} , ∀ j ∈ G ;$$

$${\sum }_{j ∈ {B}_{k}} {x}_{ij} \leq {M}_{Limit} , ∀ j ∈ G ;$$

$${\sum }_{j ∈ D} {x}_{ij} \leq {D}_{Limit} , ∀ j ∈ G ;$$

$${\sum }_{j ∈ {E}_{c}} {x}_{ij} \leq {N}_{Limit} , ∀ j ∈ G ;$$

$${\sum }_{j ∈ p} {x}_{ij} \leq {P}_{Limit} , ∀ j ∈ G ;$$

wherein, P represents the total flight operating cost; F represents the total number of flights; G represents a set of pairings; βᵢⱼ represents an operating cost of a flight allocated to a pairing; xᵢⱼ indicates whether a flight i is assigned to a pairing j, when the flight i is assigned to the pairing j, xᵢⱼ is 1, and 0 otherwise; yᵢ is a slack variable, when the flight i is allocated to the pairing j, yᵢ is 1, and when the flight i is not allocated to the pairing j, yᵢ is 0; xₘⱼ indicates whether a flight m is allocated to the pairing j; S_{TOL} represents a set of pairwise flights overlapping in time; S_{Fleet} represents a set of mismatched flight aircraft types; Bₖ represents a set of all pairings belonging to a base k; M_{Limit} represents a resource limit of the base k; D represents a set of all pairings including deadheads; D_{Limit} represents a limit of the number of deadheads in the optimization period; E_{c} represents a half pairing starting from a base E on the c^{th} day; N_{Limit} represents a resource limit of supporting a other base by the base E on a single day; p represents a set of intercontinental route-containing half pairings starting from a base p; and P_{Limit} represents a limit of the total number of the intercontinental route-containing half pairings allowed to be generated by the base p in the optimization period.

Further, the aircrew determination module 204 is configured to:

according to the determined candidate pairings and information of the aircrew, determine the roster schedule of the aircrew with the minimum flight operating cost;

determine whether the schedule of the aircrew obeys the regulatory rule; and

when the schedule of the aircrew obeys the flight regulatory rule, determine the current schedule as the schedule of the aircrew in the candidate pairings.

The aircrew determination module 204 is further configured to:

according to the information of the aircrews, determine positions of the aircrew in multiple candidate pairings, including positions in the start half pairing, positions in the intermediate duties or positions in the end half pairing; and

according to the flight operating cost, determine the schedule of the aircrew with the minimum flight operating cost.

The aircrew determination module 204 is further configured to:

when the schedule of the aircrew violates the flight regulation, select part of the aircrews to exchange schedules until the flight regulation are satisfied; and

take the valid schedule as the schedule of the aircrew in the candidate pairings.

The function of the system for operation management of aircrew of the present invention has been described in detail in the embodiment of the method shown in FIG. 1. Therefore, the details in the description of the present embodiment can refer to the related description in the foregoing embodiment, which will not be repeated herein.

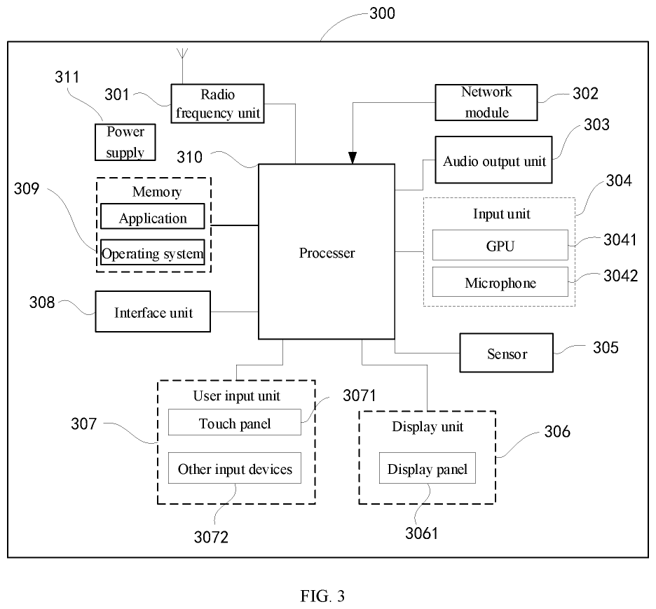

FIG. 3 is a structural schematic diagram of the hardware of a terminal device for implementing various embodiments of the present invention.

The terminal device 300 includes but is not limited to: the radio frequency unit 301, the network module 302, the audio output unit 303, the input unit 304, the sensor 305, the display unit 306, the user input unit 307, the interface unit 308, the memory 309, the processor 310, and the power supply 311. Those skilled in the art can understand that the structure of the terminal device shown in FIG. 3 does not constitute a limitation on the terminal device, and the terminal device may include more or fewer components than those shown, or a combination of certain components, or different component layouts. In the embodiment of the present invention, the terminal device includes but is not limited to a mobile phone, a tablet computer, a notebook computer, a palmtop computer, a vehicle-mounted terminal, a wearable device, and a pedometer.

The processor 310 is configured to:

according to the obtained flight schedule, determine multiple initial duties composed of a number of flights, wherein a flight schedule includes the flight number, the flight departure airport, the flight arrival airport, the flight start time and the flight end time information;

according to the multiple initial duties, determine multiple initial pairings, wherein each of the initial pairings includes a start half pairing and an end half pairing, and the start half pairing and the end half pairing are duties with different departure airports and end airports; the departure base of the start half pairing is the same as the end base of the end half pairing, and the departure base of the start half pairing is the base to which the aircrew belong;

select candidate pairings from the multiple initial pairings with the objective of minimum total flight operating cost; and

according to the determined candidate pairings and information of the aircrew, determine the roster schedule of the aircrew with a series of candidate pairings.

In the embodiment of the present invention, firstly according to the obtained flight schedule, multiple initial duties composed of a number of flights are determined, and then according to the initial duties, multiple initial pairings each including a start half pairing and an end half pairing are determined. After that, multiple candidate pairings are selected from the multiple initial pairings with the objective of minimum total flight operating cost as the objective function. Finally, according to the determined candidate pairings and information of the aircrew, the schedule of the aircrew in the multiple candidate pairings is determined. In the embodiments of the present invention, the process of generating the pairings includes: firstly building two half pairings, namely a start half pairing and an end half pairing, and then combining the half pairings with tasks of other bases to flexibly connect the pairings of the other base through half pairing bridging to maximize the coverage of flight tasks, thereby ensuring a balanced and reasonable utilization of aircrew resources and the legitimacy of aircrew rosters, while minimizing aircrew costs.

It should be understood that, in the embodiment of the present invention, the radio frequency unit 301 is configured to receive and send signals in the process of sending and receiving information or in the communication process. Specifically, after receiving downlink data from a base station, the radio frequency unit 301 sends the downlink data to the processor 310 for processing, and sends uplink data to the base station. Generally, the radio frequency unit 301 includes but is not limited to an antenna, at least one amplifier, a transceiver, a coupler, a low noise amplifier and a duplexer. In addition, the radio frequency unit 301 is further configured to communicate with the network and other devices through a wireless communication system.

The terminal device provides users with wireless broadband Internet access through the network module 302, such as helping users to send and receive emails, browse web pages, and access streaming media.

The audio output unit 303 is configured to convert audio data received by the radio frequency unit 301 or the network module 302 or stored in the memory 309 into audio signals and output the audio signals as sounds. Moreover, the audio output unit 303 is further configured to provide an audio output (such as call signal reception sound and message reception sound) related to a specific function performed by the terminal device 300. The audio output unit 303 includes a speaker, a buzzer, a receiver and others.

The input unit 304 is configured to receive audio or video signals. The input unit 304 includes the graphics processing unit (GPU) 3041 and the microphone 3042. The graphics processing unit 3041 processes image data of still images or videos obtained by an image capture device (such as a camera) in a video capture mode or an image capture mode. The processed image frame can be displayed on the display unit 306. The image frame processed by the graphics processing unit 3041 can be stored in the memory 309 (or other storage medium) or sent via the radio frequency unit 301 or the network module 302. The microphone 3042 is configured to receive sounds and process such sounds into audio data. The processed audio data can be converted into a format that can be sent to the mobile communication base station via the radio frequency unit 301 for output in the case of a telephone call mode.

The terminal device 300 further includes at least one sensor 305, such as a light sensor and a motion sensor. Specifically, the light sensor includes an ambient light sensor and a proximity sensor. The ambient light sensor is configured to adjust the brightness of the display panel 3061 according to the brightness of the ambient light. The proximity sensor is configured to turn off the display panel 3061 and/or the backlight when the terminal device 300 is moved to the ear. As a kind of motion sensor, an accelerometer sensor can measure the magnitude of acceleration in various directions (usually three axes), and can measure the magnitude and direction of gravity when it is stationary, and can be used to identify the posture of the terminal device (such as screen switching between landscape orientation and portrait orientation, related games, magnetometer posture calibration), functions related to vibration identification (such as pedometer and tap). The sensor 305 can further include a fingerprint sensor, a pressure sensor, an iris sensor, a molecular sensor, a gyroscope, a barometer, a hygrometer, a thermometer, an infrared sensor, etc., which will not be repeated herein.

The display unit 306 is configured to display information input by the user or information provided to the user. The display unit 306 includes the display panel 3061, and the display panel 3061 is configured in the form of a liquid crystal display (LCD), an organic light-emitting diode (OLED), etc.

The user input unit 307 is configured to receive inputted numeric or character information, and generate key signal input related to user settings and function control of the terminal device. Specifically, the user input unit 307 includes the touch panel 3071 and other input devices 3072. The touch panel 3071, also called a touch screen, is configured to collect the user's touch operations on or near it (for example, the user uses any suitable objects or accessories such as fingers or stylus to operate on or near the touch panel 3071). The touch panel 3071 includes a touch detection device and a touch controller. The touch detection device detects the user's touch location and detects a signal generated by the touch operation, and then transmits the signal to the touch controller. The touch controller receives touch information from the touch detection device, converts the touch information into contact coordinates, and then sends the contact coordinates to the processor 310, and receives and executes the command sent from the processor 310. In addition, the touch panel 3071 can be implemented in multiple types such as resistive, capacitive, infrared, and surface acoustic wave. In addition to the touch panel 3071, the user input unit 307 can further include other input devices 3072. Specifically, other input devices 3072 include but are not limited to a physical keyboard, function keys (such as volume control buttons and switch buttons), trackball, mouse and joystick, which will not be repeated herein.

Further, the touch panel 3071 can be overlaid on the display panel 3061. When the touch panel 3071 detects a touch operation on or near it, the touch panel 3071 transmits the touch operation to the processor 310 to determine the type of the touch event, and then the processor 310 provides a corresponding visual output on the display panel 3061 according to the type of the touch event. As shown in FIG. 3, the touch panel 3071 and the display panel 3061 are used as two independent components to implement the input and output functions of the terminal device, but in some embodiments, the touch panel 3071 and the display panel 3061 can be integrated to implement the input and output functions of the terminal device, which is not limited herein.

The interface unit 308 is an interface for connecting an external device with the terminal device 300. For example, the external device includes a wired or wireless headset port, an external power supply (or battery charger) port, a wired or wireless data port, a memory card port, a port for connecting a device with an identification module, an audio input/output (I/O) port, a video I/O port, a headphone port, etc. The interface unit 308 is configured to receive an input (such as data information and power) from the external device and transmit the received input to one or more elements in the terminal device 300. Alternatively, the interface unit 308 is configured to transmit data between the terminal device 300 and the external device.

The memory 309 is configured to store software programs and various data. The memory 309 mainly includes a storage program area and a storage data area. The storage program area is configured to store an operating system, an application program required by at least one function (such as a sound playback function and an image playback function), etc. The storage data area is configured to store data (such as audio data and phone book) created when using a mobile phone. In addition, the memory 309 includes a high-speed random access memory, and can further include a non-volatile memory, such as at least one magnetic disk storage device, a flash memory device, or other volatile solid-state storage devices.

The processor 310 is the control center of the terminal device, uses various interfaces and lines to connect the various parts of the entire terminal device, runs or executes the software programs and/or modules stored in the memory 309, and calls the data stored in the memory 309 to execute various functions of the terminal device and process the data, so as to monitor the terminal device as a whole. The processor 310 includes one or more processing units. Preferably, the processor 310 can integrate an application processor and a modem processor. The application processor mainly processes the operating system, user interface, and application programs. The modem processor mainly processes wireless communications. It can be understood that the foregoing modem processor may not be integrated into the processor 310.

The terminal device 300 can further include the power supply 311 (such as a battery) for supplying power to various components. Preferably, the power supply 311 can be logically connected to the processor 310 by a power management system, so that the functions such as charging, discharging, and power consumption management can be managed by the power management system.

In addition, the terminal device 300 includes some functional modules not shown, which will not be repeated herein.

Preferably, the embodiment of the present invention further provides a terminal device, including the processor 310, the memory 309, and a computer program stored on the memory 309 and running on the processor 310. The computer program is executed by the processor 310 to implement each process of the above-mentioned embodiment of the method for operation management of aircrew to achieve the same technical effect, which is not repeated in detail herein in order to avoid repetition.

The embodiment of the present invention further provides a computer-readable storage medium, and a computer program is stored on the computer-readable storage medium. The computer program is executed by a processor to implement each process of the above-mentioned embodiment of the method for operation management of aircrew to achieve the same technical effect, which is not repeated in detail herein in order to avoid repetition. The computer-readable storage medium includes a read-only memory (ROM), a random access memory (RAM), a magnetic disk, an optical disk or the like.

It should be noted that, the terms “include/comprise”, “contain” or any other variants thereof used herein are intended to cover non-exclusive inclusion, so that a process, method, article or device including a series of elements not only includes those elements, but also includes other elements not explicitly listed, or elements inherent to the process, method, article, or device. Without more restrictions, an element defined by the sentence “including/comprising a . . . ” does not exclude the existence of other identical elements in the process, method, article or device that includes the element.

By the description of the above embodiments, those skilled in the art can clearly understand that the above embodiments of the method can be implemented by means of software plus the necessary general hardware platform. Of course, the method can also be implemented by hardware, but in many cases the former is a preferred implementation. Based on this understanding, the technical solution of the present invention in essence or the part that contributes to the existing technology can be embodied in the form of a software product, wherein the computer software product is stored in a storage medium (such as ROM/RAM, magnetic disk and optical disc), and includes several instructions to enable a terminal (such as a mobile phone, a computer, a server, an air conditioner, or a network device) to execute the method described in each embodiment of the present invention.

The embodiments of the present invention are described above with reference to the drawings, but the present invention is not limited to the above-mentioned specific embodiments. The above-mentioned specific embodiments are only illustrative rather than restrictive. Based on the enlightenment of the present invention, those of ordinary skill in the art can make many forms without departing from the objective of the present invention and the scope of protection of the claims, and these forms shall all fall within the scope of protection of the present invention.

What is claimed is:

1. A method for an operation management of aircrew, comprising:
determining a plurality of initial duties comprising a number of flights according to an obtained flight schedule, wherein the obtained flight schedule comprises a flight number, a flight departure airport, a flight arrival airport, a flight departure time, and a flight end time;
determining a plurality of initial pairings according to the plurality of initial duties, wherein each of the plurality of initial pairings comprises a start half pairing and an end half pairing; the start half pairing and the end half pairing are duties with different departure airports and different arrival airports; a departure base of the start half pairing is the same as an end base of the end half pairing, and the aircrew belong to the departure base of the start half pairing;
determining a plurality of candidate pairings from the plurality of initial pairings by taking a minimum total flight operating cost as an objective function; and
determining a schedule of the aircrew in the plurality of candidate pairings according to the plurality of candidate pairings and information of the aircrew.

2. The method according to claim 1, wherein
the step of determining the plurality of initial pairings according to the plurality of initial duties comprises:
selecting a plurality of pairs of initial duties from the plurality of initial duties, wherein in each pair of the plurality of pairs of initial duties, a departure base of a first initial duty is the same as an end base of a second initial duty;
using a pair of initial duties in the plurality of pairs of initial duties as the start half pairing and the end half pairing of an initial pairing of the plurality of initial pairings; and
using a pairing comprising the start half pairing and the end half pairing as the initial pairing, wherein the initial pairing comprises the start half pairing, a plurality of intermediate duties, and the end half pairing, and the plurality of intermediate duties are initial duties comprising non-departure bases.

3. The method according to claim 1, wherein
the step of determining the plurality of candidate pairings from the plurality of initial pairings by taking the minimum total flight operating cost as the objective function comprises:
calculating the plurality of initial pairings by taking the minimum total flight operating cost as the objective function; and
calculating the plurality of candidate pairings by minimizing the objective function.

4. The method according to claim 3, wherein
the objective function is expressed as:
$$P = min {\sum }_{i ∈ F} {\sum }_{j ∈ G} {B}_{ij} {x}_{ij} ;$$
constraint conditions of the objective function comprise:
$${\sum }_{j ∈ G} {x}_{ij} + {y}_{i} = 1 , ∀ i ∈ F ;$$
$${x}_{ij} + {x}_{m j} \leq 1 , ∀ ( i , m ) ∈ {S}_{T O L} , ∀ j ∈ G ;$$
$${x}_{ij} + {x}_{m j} \leq 1 , ∀ ( i , m ) ∈ {S}_{Fleet} , ∀ j ∈ G ;$$
$${\sum }_{j ∈ {B}_{k}} {x}_{ij} \leq {M}_{Limit} , ∀ j ∈ G ;$$
$${\sum }_{j ∈ D} {x}_{ij} \leq {D}_{Limit} , ∀ j ∈ G ;$$
$${\sum }_{j ∈ {E}_{c}} {x}_{ij} \leq {N}_{Limit} , ∀ j ∈ G ;$$
$${\sum }_{j ∈ p} {x}_{ij} \leq {P}_{Limit} , ∀ j ∈ G ;$$
wherein, P represents the minimum total flight operating cost; F represents a set of the flights; G represents a set of the plurality of candidate pairings; βᵢⱼ represents an operating cost of a flight allocated to a candidate pairing of the plurality of candidate pairings; xᵢⱼ indicates whether a flight i is allocated to a candidate pairing j of the plurality of candidate pairings, when the flight i is allocated to the candidate pairing j, xᵢⱼ is 1, and when the flight i is not allocated to the candidate pairing j, xᵢⱼ is 0; yᵢ is a slack variable, when the flight i is allocated to the candidate pairing j, yᵢ is 1, and when the flight i is not allocated to the candidate pairing j, yᵢ is 0; xₘⱼ indicates whether a flight m is allocated to the candidate pairing j; S_{TOL} represents a set of pairwise flights overlapping in time; S_{Fleet} represents a set of mismatched flight aircraft types; Bₖ represents a set of pairings belonging to a base k; M_{Limit} represents a resource limit of the base k; D represents a set of pairings comprising deadheads; D_{Limit} represents a limit of a number of the deadheads in an optimization period; E_{c} represents a half pairing starting from a base E on a c^{th} day; N_{Limit} represents a resource limit of supporting bases excluding the base E by the base E on a single day; p represents a set of intercontinental route-containing half pairings starting from a base p; and P_{Limit} represents a limit of a total number of the intercontinental route-containing half pairings allowed to be generated by the base p in the optimization period.

5. The method according to claim 1, wherein
the step of determining the schedule of the aircrew in the plurality of candidate pairings according to the plurality of candidate pairings and the information of the aircrew comprises:
determining the schedule of the aircrew with the minimum total flight operating cost according to the plurality of candidate pairings and the information of the aircrew;
determining whether the schedule of the aircrew obeys flight regulation parameters; and
determining a current schedule as the schedule of the aircrew in the plurality of candidate pairings when the schedule of the aircrew obeys the flight regulation parameters.

6. The method according to claim 5, wherein
the step of determining the schedule of the aircrew with the minimum total flight operating cost according to the plurality of candidate pairings and the information of the aircrew comprises:
determining positions of the aircrew in the plurality of candidate pairings according to the information of the aircrew, wherein the positions comprise positions in the start half pairing, positions in the plurality of intermediate duties or positions in the end half pairing; and
determining the schedule of the aircrew with the minimum total flight operating cost according to the minimum total flight operating cost.

7. The method according to claim 6, further comprising:
when the schedule of the aircrew violates the flight regulation parameters, selecting a part of the aircrew to exchange schedules until an exchanged legal schedule does not violate the flight regulation parameters; and
using the exchanged legal schedule as the schedule of the aircrew in the plurality of candidate pairings.

8. A system for an operation management of aircrew, comprising:
a first determination module, configured to determine a plurality of initial duties comprising a number of flights according to an obtained flight schedule, wherein the obtained flight schedule comprises a flight number, a flight departure airport, a flight arrival airport, a flight departure time, and a flight arrival time;
a second determination module, configured to determine a plurality of initial pairings according to the plurality of initial duties, wherein each of the plurality of initial pairings comprises a start half pairing and an end half pairing; the start half pairing and the end half pairing are duties with different departure airports and different arrival airports; a departure base of the start half pairing is the same as an end base of the end half pairing, and the aircrew belong to the departure base of the start half pairing;
a pairing determination module, configured to determine a plurality of candidate pairings from the plurality of initial pairings by taking a minimum total flight operating cost as an objective function; and
an aircrew determination module, configured to determine a schedule of the aircrew in the plurality of candidate pairings according to the plurality of candidate pairings and information of the aircrew.

9. The system according to claim 8, wherein
the second determination module is configured to:
select a plurality of pairs of initial duties from the plurality of initial duties, wherein in each pair of the plurality of pairs of initial duties, a departure base of a first initial duty is the same as an end base of a second initial duty;
use a pair of initial duties in the plurality of pairs of initial duties as the start half pairing and the end half pairing of an initial pairing of the plurality of initial pairings; and
use a pairing comprising the start half pairing and the end half pairing as the initial pairing, wherein the initial pairing comprises the start half pairing, a plurality of intermediate duties, and the end half pairing, and the plurality of intermediate duties are initial duties comprising non-departure bases.

10. A terminal device, comprising:
a memory, a processor, and a computer program; wherein
the computer program is stored on the memory and running on the processor, and the computer program is executed by the processor to implement the steps of the method according to claim 1.

11. The terminal device according to claim 10, wherein
the step of determining the plurality of initial pairings according to the plurality of initial duties comprises:
selecting a plurality of pairs of initial duties from the plurality of initial duties, wherein in each pair of the plurality of pairs of initial duties, a departure base of a first initial duty is the same as an end base of a second initial duty;
using a pair of initial duties in the plurality of pairs of initial duties as the start half pairing and the end half pairing of an initial pairing of the plurality of initial pairings; and
using a pairing comprising the start half pairing and the end half pairing as the initial pairing, wherein the initial pairing comprises the start half pairing, a plurality of intermediate duties, and the end half pairing, and the plurality of intermediate duties are initial duties comprising non-departure bases.

12. The terminal device according to claim 10, wherein
the step of determining the plurality of candidate pairings from the plurality of initial pairings by taking the minimum total flight operating cost as the objective function comprises:
calculating the plurality of initial pairings by taking the minimum total flight operating cost as the objective function; and
calculating the plurality of candidate pairings by minimizing the objective function.

13. The terminal device according to claim 12, wherein
the objective function is expressed as:
$$P = min {\sum }_{i ∈ F} {\sum }_{j ∈ G} {B}_{ij} {x}_{ij} ;$$
constraint conditions of the objective function comprise:
$${\sum }_{j ∈ G} {x}_{ij} + {y}_{i} = 1 , ∀ i ∈ F ;$$
$${x}_{ij} + {x}_{m j} \leq 1 , ∀ ( i , m ) ∈ {S}_{T O L} , ∀ j ∈ G ;$$
$${x}_{ij} + {x}_{m j} \leq 1 , ∀ ( i , m ) ∈ {S}_{Fleet} , ∀ j ∈ G ;$$
$${\sum }_{j ∈ {B}_{k}} {x}_{ij} \leq {M}_{Limit} , ∀ j ∈ G ;$$
$${\sum }_{j ∈ D} {x}_{ij} \leq {D}_{Limit} , ∀ j ∈ G ;$$
$${\sum }_{j ∈ {E}_{c}} {x}_{ij} \leq {N}_{Limit} , ∀ j ∈ G ;$$
$${\sum }_{j ∈ p} {x}_{ij} \leq {P}_{Limit} , ∀ j ∈ G ;$$
wherein, P represents the minimum total flight operating cost; F represents a set of the flights; G represents a set of the plurality of candidate pairings; βᵢⱼ represents an operating cost of a flight allocated to a candidate pairing of the plurality of candidate pairings; xᵢⱼ indicates whether a flight i is allocated to a candidate pairing j of the plurality of candidate pairings, when the flight i is allocated to the candidate pairing j, xᵢⱼ is 1, and when the flight i is not allocated to the candidate pairing j, xᵢⱼ is 0; yᵢ is a slack variable, when the flight i is allocated to the candidate pairing j, yᵢ is 1, and when the flight i is not allocated to the candidate pairing j, yᵢ is 0; xₘⱼ indicates whether a flight m is allocated to the candidate pairing j; S_{TOL} represents a set of pairwise flights overlapping in time; S_{Fleet} represents a set of mismatched flight aircraft types; Bₖ represents a set of pairings belonging to a base k; M_{Limit} represents a resource limit of the base k; D represents a set of pairings comprising deadheads; D_{Limit} represents a limit of a number of the deadheads in an optimization period; E_{c} represents a half pairing starting from a base E on a c^{th} day; N_{Limit} represents a resource limit of supporting bases excluding the base E by the base E on a single day; p represents a set of intercontinental route-containing half pairings starting from a base p; and P_{Limit} represents a limit of a total number of the intercontinental route-containing half pairings allowed to be generated by the base p in the optimization period.

14. The terminal device according to claim 10, wherein
the step of determining the schedule of the aircrew in the plurality of candidate pairings according to the plurality of candidate pairings and the information of the aircrew comprises:
determining the schedule of the aircrew with the minimum total flight operating cost according to the plurality of candidate pairings and the information of the aircrew;
determining whether the schedule of the aircrew obeys flight regulation parameters; and
determining a current schedule as the schedule of the aircrew in the plurality of candidate pairings when the schedule of the aircrew obeys the flight regulation parameters.

15. The terminal device according to claim 14, wherein
the step of determining the schedule of the aircrew with the minimum total flight operating cost according to the plurality of candidate pairings and the information of the aircrew comprises:
determining positions of the aircrew in the plurality of candidate pairings according to the information of the aircrew, wherein the positions comprise positions in the start half pairing, positions in the plurality of intermediate duties or positions in the end half pairing; and
determining the schedule of the aircrew with the minimum total flight operating cost according to the minimum total flight operating cost.

16. The terminal device according to claim 15, wherein
when the schedule of the aircrew violates the flight regulation parameters, selecting a part of the aircrew to exchange schedules until an exchanged legal schedule does not violate the flight regulation parameters; and
using the exchanged legal schedule as the schedule of the aircrew in the plurality of candidate pairings.
